(19) United States
(12) Patent Application Publication
(10) Pub. No.: US 2021/0294848 A1
(43) Pub. Date: Sep. 23, 2021

(54) CONVERSION OF WELL OPERATION INFORMATION FOR CLOUD-NATIVE APPLICATIONS

(71) Applicant: Chevron U.S.A. Inc., San Ramon, CA (US)

(72) Inventor: Shaddick Keagy, Richmond, TX (US)

(21) Appl. No.: 16/825,910

(22) Filed: Mar. 20, 2020

(51) Int. Cl. G06F 16/835; G06F 16/26

(52) U.S. Cl. CPC G06F 16/8358; G06F 16/26

(57) ABSTRACT

Well operation information arranged in the extensible markup language format may be converted into a cloud-native format. The converted information may be provided to a cloud-native application to facilitate operation of the well.

### FIELD

The present disclosure relates generally to the field of transforming data between an extensible markup-language format and a cloud-native format for well operations.

### BACKGROUND

Information characterizing operation of a well may be arranged in an extensible markup language format, such as wellsite information transfer standard markup language format. Use of such information may require conversion into a proprietary format or use of custom adaptors to populate proprietary solutions.

### SUMMARY

This disclosure relates to transforming data for well operations. Operation information for a well and/or other information may be obtained from a data store. The operation information may characterize operation of the well. The operation information may be arranged in an extensible markup language format. Cloud-native operation information may be generated based on the operation information and/or other information. The cloud-native operation information may include one or more portions of the operation information arranged in a cloud-native format. The cloud-native operation information may be provided to one or more cloud-native application(s). The cloud-native application(s) may utilize the cloud-native operation information to facilitate the operation of the well.

A system that transforms data for well operations may include one or more electronic storage, one or more processors and/or other components. The electronic storage may store operation information for a well, information relating to a well, information relating to operation of a well, information relating to a data store, information relating to extensible markup language format, cloud-native operation information, information relating to cloud-native format, information relating to conversion between extensible markup language format and cloud-native format, information relating to cloud-native application, and/or other information.

The processor(s) may be configured by machine-readable instructions. Executing the machine-readable instructions may cause the processor(s) to facilitate transforming data for well operations. The machine-readable instructions may include one or more computer program components. The computer program components may include one or more of an obtain component, a generation component, a provision component, and/or other computer program components.

The obtain component may be configured to obtain information from one or more locations. The obtain component may be configured to obtain operation information for a well and/or other information from one or more data stores. The operation information may characterize operation of the well. The operation information may be arranged in an extensible markup language format and/or other formats. In some implementations, the operation of the well may include a drilling operation, a completion operation, a production operation, or other operation of the well.

In some implementations, the extensible markup language format may include wellsite information transfer standard markup language format. In some implementations, the operation information may be obtained from the data store(s) as one or more wellsite information transfer standard markup language documents.

In some implementations, the operation information may be obtained from the data store(s) based on a set of queries. In some implementations, the set of queries may include a well query, a wellbore query, an item query, and/or other queries.

The generation component may be configured to generate cloud-native operation information based on the operation information and/or other information. The cloud-native operation information may include one or more portions of the operation information arranged in a cloud-native format.

In some implementations, the cloud-native format may include JavaScript Object Notation format. In some implementations, the cloud-native operation information may be generated as one or more JavaScript Object Notation messages.

In some implementations, the portion(s) of the operation information may be arranged in the cloud-native format in the cloud-native operation information based on a list of elements, corresponding data types to be converted from the operation information into the cloud-native operation information, and/or other information.

The provision component may be configured to provide the cloud-native operation information to one or more cloud-native applications. The cloud-native application(s) may utilize the cloud-native operation information to facilitate the operation of the well.

In some implementations, the cloud-native application(s) may include a data visualization application, a data analytic application, and/or other cloud-native applications.

In some implementations, output of the data analytic application may be arranged in the JavaScript Object Notation format. Output of the data analytic application may be converted into the wellsite information transfer standard markup language format. The converted output of the data analytic application may be provided to the data store(s) for use in the operation of the well.

These and other objects, features, and characteristics of the system and/or method disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a,” “an,” and “the” include plural referents unless the context clearly dictates otherwise.

### BRIEF DESCRIPTION OF THE DRAWINGS

FIG. 1 illustrates an example system that transforms data for well operations.

FIG. 2 illustrates an example method for transforming data for well operations.

FIGS. 3, 4, and 5 illustrate example information relating to a well.

FIG. 6 illustrates an example list of elements and corresponding data types to be converted.

FIG. 7 illustrates an example cloud-native message.

FIG. 8A illustrates an example flow for converting a WITSML document into a cloud-native message.

FIG. 8B illustrates an example flow for converting a cloud-native message into a WITSML document.

### DETAILED DESCRIPTION

The present disclosure relates to transforming data for well operations. Well operation information arranged in the extensible markup language format may be converted into a cloud-native format. The converted information may be provided to a cloud-native application to facilitate operation of the well.

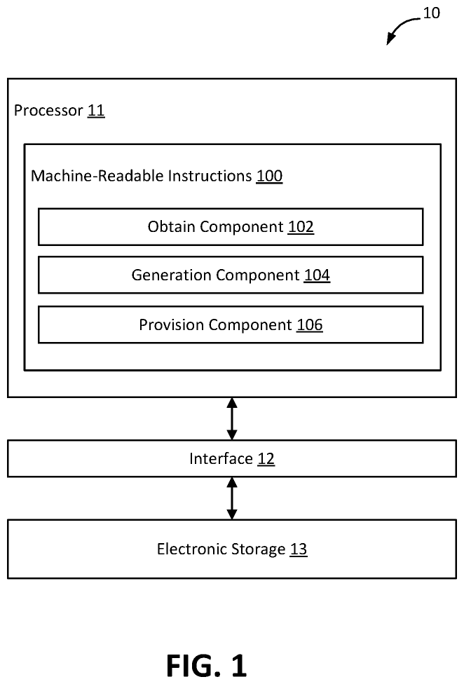

The methods and systems of the present disclosure may be implemented by and/or in a computing system, such as a system 10 shown in FIG. 1. The system 10 may include one or more of a processor 11, an interface 12 (e.g., bus, wireless interface), an electronic storage 13, and/or other components. Operation information for a well and/or other information may be obtained by the processor 11 from a data store. The operation information may characterize operation of the well. The operation information may be arranged in an extensible markup language format. Cloud-native operation information may be generated by the processor 11 based on the operation information and/or other information. The cloud-native operation information may include one or more portions of the operation information arranged in a cloud-native format. The cloud-native operation information may be provided by the processor 11 to one or more cloud-native application(s). The cloud-native application(s) may utilize the cloud-native operation information to facilitate the operation of the well.

The electronic storage 13 may be configured to include electronic storage medium that electronically stores information. The electronic storage 13 may store software algorithms, information determined by the processor 11, information received remotely, and/or other information that enables the system 10 to function properly. For example, the electronic storage 13 may store operation information for a well, information relating to a well, information relating to operation of a well, information relating to a data store, information relating to extensible markup language format, cloud-native operation information, information relating to cloud-native format, information relating to conversion between extensible markup language format and cloud-native format, information relating to cloud-native application, and/or other information

The processor 11 may be configured to provide information processing capabilities in the system 10. As such, the processor 11 may comprise one or more of a digital processor, an analog processor, a digital circuit designed to process information, a central processing unit, a graphics processing unit, a microcontroller, an analog circuit designed to process information, a state machine, and/or other mechanisms for electronically processing information. The processor 11 may be configured to execute one or more machine-readable instructions 100 to facilitate transforming data for well operations. The machine-readable instructions 100 may include one or more computer program components. The machine-readable instructions 100 may include one or more of an obtain component 102, a generation component 104, a provision component 104, and/or other computer program components.

The obtain component 102 may be configured to obtain information relating to a well and/or other information. Obtaining information relating to a well may include one or more of accessing, acquiring, analyzing, determining, examining, identifying, loading, locating, opening, receiving, retrieving, reviewing, selecting, storing, utilizing, and/or otherwise obtaining the information relating to the well. The obtain component 102 may be configured to obtain information relating to a well from one or more locations. For example, the obtain component 102 may obtain information relating to a well from a storage location, such as the electronic storage 13, electronic storage of a device accessible via a network, and/or other locations. The obtain component 102 may obtain information relating to a well from one or more hardware components (e.g., a computing device, a component of a computing device, a sensor, a component of a drilling tool) and/or one or more software components (e.g., software running on a computing device). The obtain component 102 may obtain information relating to a well from one or more data stores. Information relating to a well may be stored within a single file or multiple files.

Information relating to a well may include information that that characterizes one or more aspects of the well. A well may refer to a hole or a tunnel in the ground. A well may be drilled in the ground for exploration and/or recovery of natural resources in the ground. For example, a well may be drilled in the ground to aid in extraction of petrochemical fluid (e.g., oil, gas, petroleum, fossil fuel). A well may be drilled in one or more directions. For example, a well may include a vertical well, a horizontal well, a deviated well, and/or other type of well.

Information relating to a well may include information obtained from the well, information about the well, information processed for the well, and/or other information relating to the well. For example, information relating to a well may include operation information for the well. The operation information may characterize operation of the well. Operation of a well may refer to performance of work on and/or usage of a well. Operation of a well may be divided into different stages and/or types of operation. For example, operation of the well may include a drilling operation, a completion operation, a production operation, or other operation of the well. In some implementations, operation information for a well may include information relating to channels for the well and/or sensor data for the well. In some implementations, operation information for a well may include one or more reports generated for the well (e.g., change log, reports on run of pipe). In some implementations, operation information for a well may include one or more media items (e.g., picture file, video file, audio file) of the well. In some implementations, operation information for a well may include information processed for the well (e.g., output of a cloud application relating to a well).

The operation information may characterize operation of a well by including information that characterizes (e.g., reflects, quantifies, identifies, defines, is used to determine) one or more values, qualities, attributes, features, and/or other aspects of operation of the well. For example, the operation information may include information that characterizes values of well operation parameters. A well operation parameter may refer to a numerical and/or other measurable factor that form one of a set that defines operation of the well and/or sets the conditions of operation of the well. For example, a well operation parameter may include parameters of the well, parameters of tools for the well, and/or parameters of other things that affect the well.

For example, a well operation parameter may include properties of location at which a well is drilled (drilling location) and/or properties of a tool used for the well (e.g., a drilling tool, natural resource recovery tool, waste/by-product removal tool). A well operation parameter may include one or more features and/or qualities of the drilling location and/or the tool. A well operation parameter may include one or more features and/or qualities of the well and/or wellbore. For example, for a wellbore, a well operation parameter may include location of the wellbore, geometry of the wellbore (e.g., where the casing starts and stops, hole size, well design), predicated path/placement of the wellbore, physical and/or chemical composition of the wellbore (e.g., type of steel/tubing running through the wellbore), information obtained from wellbore samples, potential hazards within the wellbore, sensor/alarm logs for the wellbore, formation markers, types of fluid use in the wellbore, types of equipment used in the wellbore, and/or other operation parameters for the wellbore.

A well operation parameter may include a parameter applied and/or used to operate a tool and/or a condition of the environment around/near the tool during operation. For example, for a drilling tool, a well operation parameter may include one or more of key indicators, drilling depth, total gas present, hookload, depth of bit, block position, torque, rotation speed, rate of penetration, weight on bit, standpipe pressure, flowrate, pressure, stress, strain, mud weight in/out, active pit total, volume change, hole displacement, tank volume, strokes speed, pump rate, equivalent circulating density, equivalent static density, whether one or more pumps are on or off, pick-up weight, slack-off weight, direction of movement of bit depth, direction of movement of block position, reamer neutral weight, bottom hole assembly speed, drag, block weight, friction factor, trip number, tool vibration, and/or other operation parameter(s). Other well operation parameters are contemplated.

The operation information may be obtained at different times to obtain different (e.g., updated) information for a well. For example, the obtain component 102 may obtain the operation information for a well at periodic intervals and/or on-demand to receive operating information that characterizes operation of a well at different times and/or at different stages.

The operation information may be arranged in one or more formats. For example, the operation information may be arranged in a markup language format, such as an extensible markup language format, and/or other formats. In some implementations, the extensible markup language format may include wellsite information transfer standard markup language (WITSML) format. For example, the operation information may be stored in our or more wellsite information transfer standard markup language documents, with the information within the document(s) arranged in accordance with the wellsite information transfer standard markup language format.

Wellsite information transfer standard markup language format may provide a standard for storing and/or sharing information about a well. For example, wellsite information transfer standard markup language format may be used as a standard for transmitting well-site information from a rig to different stakeholders in the oil and gas industry. For instance, wellsite information transfer standard markup language format may be used for drilling rig/offshore platform to communicate information to users/entities operating the drilling rig/offshore platform and/or to other stakeholders. Wellsite information transfer standard markup language format may be used to arrange information about a well into a standard format. For example, wellsite information transfer standard markup language format may be used to arrange information about drilling a well and/or extraction of petrochemical fluid (e.g., oil, gas, petroleum, fossil fuel) from a well. Use of other formats are contemplated.

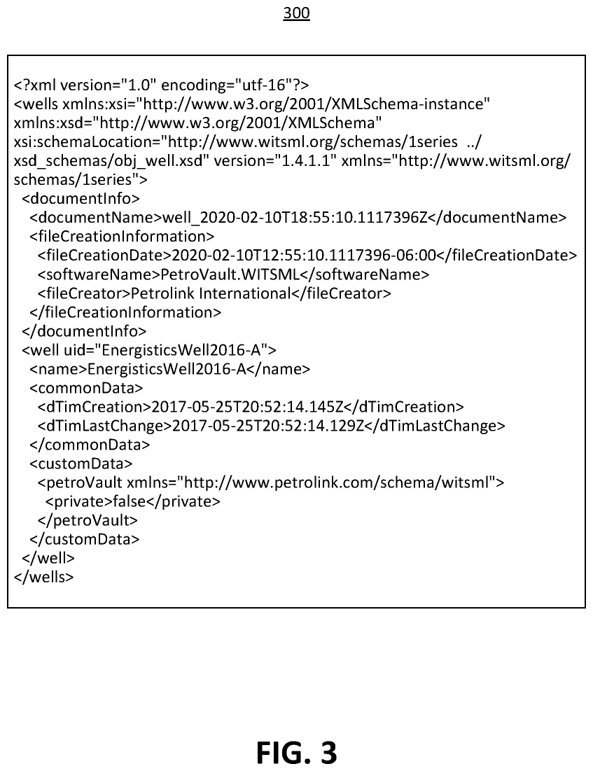

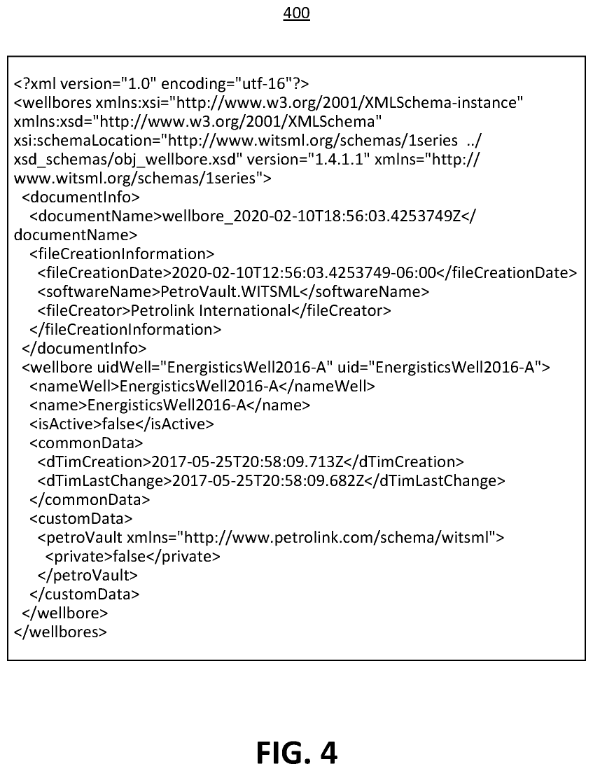

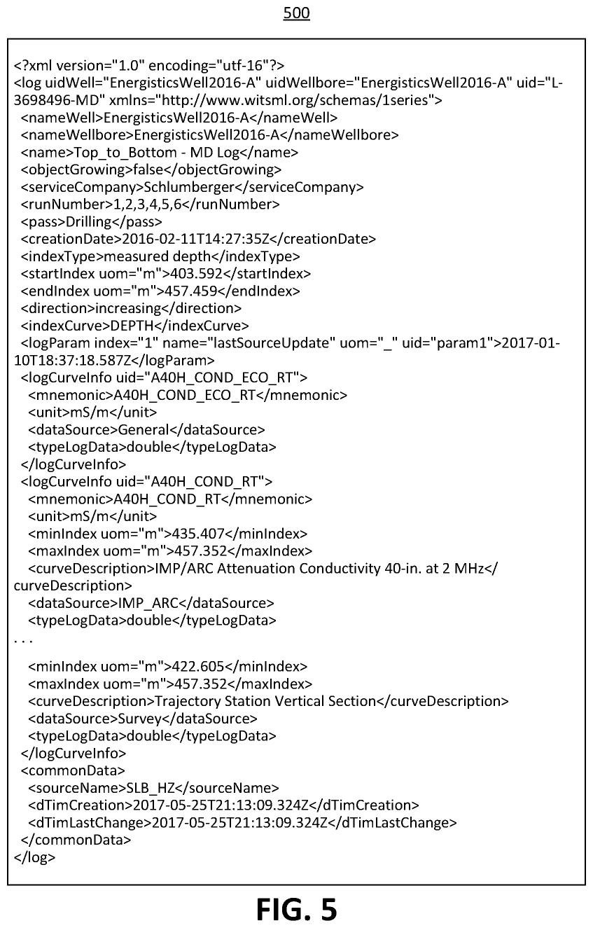

FIGS. 3, 4, and 5 illustrate example information relating to a well. FIG. 3 illustrates example well information 300. The well information 300 may be arranged in wellsite information transfer standard markup language format. FIG. 4 illustrates example wellbore information 400. The wellbore information 400 may be arranged in wellsite information transfer standard markup language format. FIG. 5 illustrates example well log information 500. The well log information 500 may be arranged in wellsite information transfer standard markup language format.

In some implementations, the operation information may be obtained from one or more data store(s) as one or more wellsite information transfer standard markup language documents. For example, one or more of the information 300, 400, 500 may be obtained from a data store (e.g., a WITSML data store) as one or more WITSML documents. In some implementations, the operation information may be obtained from the data store(s) based on a set of queries. A set of queries may include one or more queries. In some implementations, the set of queries may include a well query, a wellbore query, an item query, and/or other queries.

Different types of queries may be used to retrieve different operation information from a data store. For example, a well query may be used to retrieve information about a particular well, such as the well information 300 shown in FIG. 3. A wellbore query may be used to retrieve information about a particular wellbore, such as the wellbore information 400 shown in FIG. 4. An item query may be used to retrieve information about specific item for a well/wellbore, such as the well log information 500 shown in FIG. 5. The operation information obtained from the data store(s) may include information provided by the data store(s) in response to the quer(ies). Other types of queries are contemplated.

As another example, information relating to a well may include information output by one or more cloud-native applications. For instance, a cloud-native application may be provided with operation information for a well (converted into a cloud-native format), and the cloud-native application may output one or more information using the operation information. For example, a cloud-native application may perform data analytics using the operation information and output results of the data analytics. The obtain component 102 may obtain the output of the data analytic application. Other information relating to a well are contemplated.

The generation component 104 may be configured to generate converted information relating to the well. Converted information relating to the well may be generated based on the information relating to the well (obtained by the obtain component 102) and/or other information. The generation component 104 may generate the converted information relating to the well based on conversion of the information relating to the well into one or more different formats. For example, the obtain component 102 may obtain operation information arranged in an extensible markup language format and the generation component 104 may generate cloud-native operation information based on the operation information arranged in the extensible markup language format and/or other information. The cloud-native operation information may include entirety or one or more portions of the operation information arranged in a cloud-native format. That is, the generation component 104 may transform some or all of the information arranged in the extensible markup language format so that they are arranged in the cloud-native format in the cloud-native operation information.

A cloud-native format may refer to format in which information is arranged for storage and/or sharing by a cloud application. A cloud-native format may refer to information-exchange format for cloud applications. A cloud-native format may provide a standard for storing and/or sharing information between cloud applications. A cloud application may refer to an application that operates in the cloud. A cloud application may refer to a program and/or software where some or all of the processing logic and/or data storage is processed in the cloud. A cloud application may refer to a program and/or software that is interacted by a user/another program using remote communication, such as Internet communication.

For example, the cloud-native format may include JavaScript Object Notation (JSON) format and/or other format. For instance, the operation information may be obtained by the obtain component 102 from a data store as one or more WITSML documents, and the generation component 104 may generate one or more JavaScript Object Notation messages from information contained within the WITSML document(s). The operation information may be obtained by the obtain component 102 from a cloud application as one or more JSON messages, and the generation component 104 may generate one or more WITSML document(s) from information contained within the JSON messages.

Thus, information originally arranged in a markup language format may be converted to be arranged in a cloud-native format. Such re-arrangement of information for a well into different formats may enable use of information normally isolated in legacy/proprietary applications and stores to cloud analytics and/or cloud-based solutions. For example, a WITSML document containing information for a well may be converted into JSON messages that may be consumed natively by cloud native event hubs and/or Internet-of-Things hub end points.

For example, many proprietary data standards and custom APIs may exist for . native drilling and completions information. One way to access data stores for such data may be to use a common data standard API, such as WITSML. However, a vast amount of operational competency may be needed to perform analytics on a WITSML native data set. To overcome this, information may be converted into a propriety format or custom adaptors may be built to populate other propriety solutions. However, such attempts to use WITSML information may not provide data accessibility to the analytics that are desired to be performed.

To cut down on the amount of information replication and to expose the information into more cloud friendly environment, WITSML information may be converted into cloud-native format, such as JSON format. The converted information may be processed by cloud native tools and systems, enabling use of technologies not specifically tailored to well drilling/petrochemical fluid extraction industry. For example, rather than being limited to processing native exclusively within the WITSML standard or building custom adaptors to meet each individual software suit or application, WITSML information may be treated like an Internet-of-Things device, and JSON messages may be generated from the WITSML information. The conversion of information from WITSML format into JSON format may enable Internet-of-Things enabled technologies and/or analytics to be used for information originally arranged in the WITSML format. The conversion of information from WITSML format into JSON format may enable the transformed information to move freely within a cloud framework and may enable the transformed information to be integrated with cloud technology.

The generation component 104 may generate the converted information relating to the well based on conversion of the entirety of the information relating to the well and/or conversion of one or more portions of the information relating to the well. For example, generation component 104 may convert entirety of operation information from a markup language format into a cloud-native format, or vice versa. As another example, generation component 104 may convert portion(s) of operation information from a markup language format into a cloud-native format, or vice versa.

Selective conversion of information relating to a well may facilitate more efficiently transfer and/or utilization of information. For example, vast amount of data may be stored within the WITSML structure, and converting/transferring/processing entirety of information WITSML information may be resource intensive (e.g., processing time, memory consumption). WITSML information may include information not relevant for processing by a cloud application. Selective portions of the WITSML information may be retrieved from a WITSML data store for conversion, transfer, and/or processing. Selective portions of the obtained WITSML information may be converted, transferred, and/or processed.

In some implementations, the portion(s) of the operation information arranged in the markup language format may be arranged in the cloud-native format in the cloud-native operation information based on one or more lists of elements, corresponding data types to be converted from the operation information into the cloud-native operation information, and/or other information. The list(s) may provide for mapping of information between different formats for conversion. That is, list(s) of elements and corresponding data types for the listed elements may be used to identify which portions of the operation information may be converted into a cloud-native format. For example, list(s) of elements and corresponding data types for the listed elements may be used to identify which portions of the WITSML information may be identified for conversion and inclusion in a JSON message. Similarly, list(s) of elements and corresponding data types for the listed elements may be used to identify type of information contained in a JSON message for conversion into WITSML information.

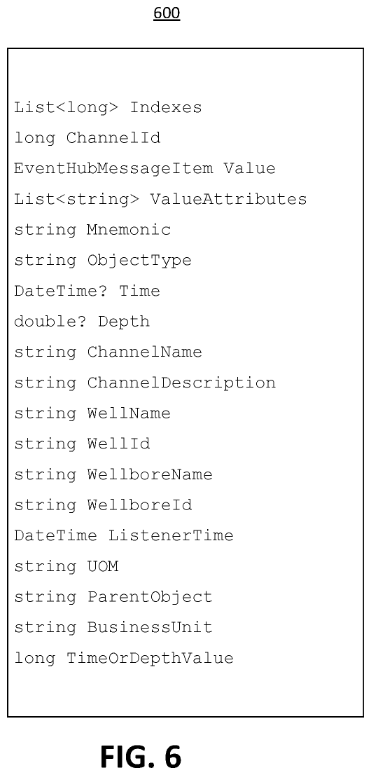

FIG. 6 illustrates an example list 600 of elements and corresponding data types to be converted. The list 600 may identify which elements in the WITSML information are pulled for inclusion in the JSON message, and may identify the data type of the pulled information. The generation component 104 may use the list 600 to identify and pull relevant portions of the information relating to a well obtained by the obtain component 102. For example, the generation component 104 may use the list 600 to identify and pull relevant portions of the well information 300 shown in FIG. 3, the wellbore information 400 shown in FIG. 4, and/or the well log information 500 shown in FIG. 5. Other lists of elements and corresponding data types are contemplated.

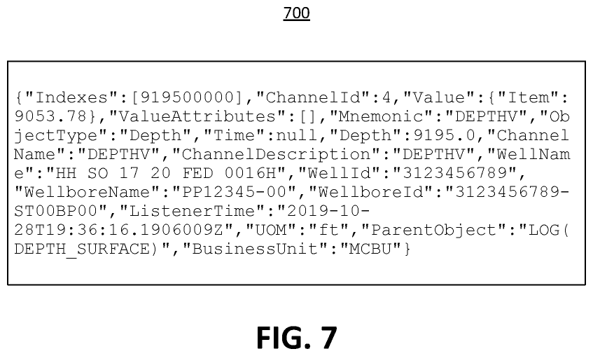

FIG. 7 illustrates an example cloud-native message 700. The cloud-native message 700 may include one or more portions of the operation information arranged in a cloud-native format. For example, the cloud-native message 700 many include portions of WITSML information arranged in the JSON format. The cloud-native message 700 may include elements of the WITSML information in quotes. The elements may be placed within the cloud-native message based on a listing of elements and corresponding data types, such as the list 600 shown in FIG. 6. The WITSML information may be parsed for the elements within the cloud-native message 700, and the cloud-native message 700 may be populated with the values from corresponding portions of the WITSML information. The “ListenerTime” of the cloud-native message 700 may provide a time stamp for the cloud-native message 700. For example, the value of the “ListenerTime” may correspond to when the cloud-native message 700 was generated and/or when the cloud-native message 700 was received (e.g., by a cloud application).

Thus, light and targeted cloud-native messages may be generated for use within a cloud framework. For example, rather than converting and transferring large WITSML information stored in a WITSML database, the relevant portions of WITSML information may be pulled and arranged within one or more JSON messages. The JSON message(s) may include information needed by cloud applications to facilitate operation of a well.

For instance, referring to FIG. 7, the cloud-native message 700 may include

“Indexes” value that enables the cloud-native message 700 to be passed around within the cloud framework. Information between “Indexes” and “ListenerTime” may include information pulled from one or more WITSML documents based on the list 600. “ChannelID” may indicate corresponding channel of “ParentObject” “LOG(DEPTH_SURFACE),” which may indicate raw signals that was used to generate the information. “Value” may indicate the value of interest, such as value of depth vertical . “ValueAttribute” may refer to special attributes of “Value,” and empty brackets may indicate that no special attributes exist for “Value.” “Mnemonic” may refer to a tag from WITSML document(s) (depth vertical). “ObjectType” may indicate the value type of data (e.g., time-based data, depth based data). “Time” may indicate the corresponding time, and may be empty for depth based data. “Depth” may refer to an independent depth variable associated with the value of interest. For example, the value of 9195.0 may indicate that when the wellbore's total depth was 9195, the total vertical depth was 9053.78. “ChannelName” may indicate name of the channel and “ChannelDescription” may include string text that describes the channel. The cloud-native message 700 may include other metadata from other WITSML tags, such as “WellName,” “WellId,” “WellboreName,” and “Wellboreld.” “UOM” may indicate the unit of measure for “Value,” and “ParentObject” may indicate the WITSML object from which information was obtained. “BusinessUnit” may indicate to which business unit is associated with the well. One or more of the information contained within the cloud-native message 700 may be used to filter different types of cloud-native messages. For example, “ParentObject” may be used to filter for information that is coming from the parent object “LOG(DEPTH_SURFACE).”

As another example, the obtain component 102 may obtain operation information arranged in a cloud-native format and the generation component 104 may generate markup-language operation information based on the operation information arranged in the cloud-native format and/or other information. The markup-language operation information may include entirety or one or more portions of the operation information arranged in a markup language format (e.g., extensive markup language format, wellsite information transfer standard markup language format). That is, the generation component 104 may transform some or all of the information arranged in the cloud-native format so that they are arranged in the markup language format in the markup-language operation information. In some implementations, the operation information arranged in the cloud-native format may be obtained from one or more cloud applications.

In some implementations, the operation information arranged in the cloud-native format may be converted to be arranged in a markup language format based on a reversal of the conversion process described above. For example, list(s) of elements and corresponding data types for the listed elements may be used to identify type of information contained in a JSON message for conversion into WITSML information. The list(s) may be used to determine which portions of the JSON message will be selected and/or how the selected portions will be converted for arrangement in the markup language format. The converted information may be provided to one or more data stores (e.g., WITSML data store) to facilitate operation of the well.

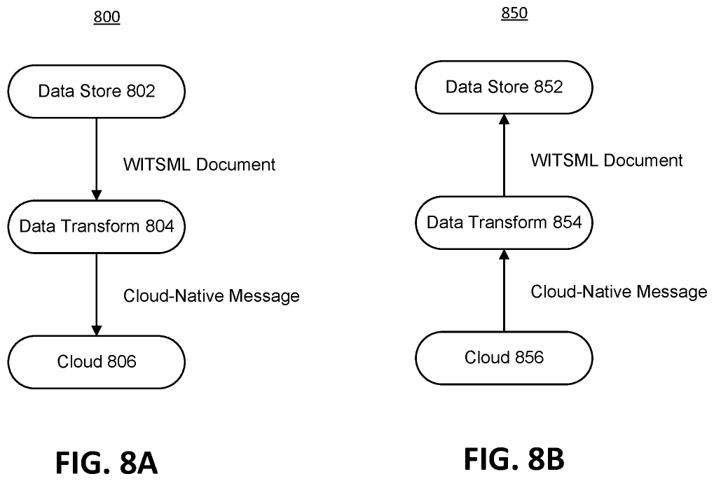

For example, FIG. 8A illustrates an example flow 800 for converting a WITSML document into a cloud-native message, and FIG. 8B illustrates an example flow 850 for converting a cloud-native message into a WITSML document. In the flow 800, a data store 802 may provide a WITSML document containing information relating to a well, with the information arranged in the WITSML format. The information within the WITSML document may be converted using a data transform 804. The converted information may be arranged in the cloud-native format and may be provided to the cloud 806 (cloud application(s)) using a cloud-native message (JSON message).

In the flow 850, the cloud 856 may provide information relating to a well in a cloud-native message, with the information arranged in the cloud-native format. For example, a cloud application may include a data analytic application that performs computations on operation information for a well (after conversion into cloud-native format) to provide recommendations on one or more well operation parameter to be used in the future. The information may be provided by the data analytic application in a JSON format. The information within the cloud-native message may be converted using a data transform 854. The converted information may be arranged in the WITSML format and may be provided (e.g., exported) to the data store 852 (e.g., WITSML data store) using a WITSML document.

Thus, information originally arranged in a cloud-native format may be converted to be arranged in a markup language format. Such re-arrangement of information for a well into different formats may enable communication and coordination between technologies specifically tailored to well drilling/petrochemical fluid extraction industry and cloud technologies. The conversion of information between different formats may serve as intermediary between specialized technologies that use markup language format (e.g., WITSML format) and cloud technologies that use cloud-native format (e.g., JSON format). Such re-arrangement of information for a well into different formats may enable use of both legacy applications that use markup language format and new applications that use cloud-native format. For example, such re-arrangement of information for a well into different formats may enable Internet-of-Things capabilities for well drilling/petrochemical fluid extraction technologies.

The provision component 106 may be configured to provide the converted information relating to a well and/or other information. Providing information relating to a well may include one or more of making the information relating to the well available for use, supplying the information relating to the well, transmitting the information relating to the well, and/or otherwise providing the information relating to the well. For example, the provision component 106 may be configured to push (e.g., transmit) information relating to a well to one or more cloud applications, one or more data stores, and/or other locations. The provision component 106 may be configured to make information relating to a well ready for pull (e.g., download) by one or more cloud applications, one or more data stores, and/or other locations. Other provision of information relating to a well are contemplated.

The provision component 106 may be configured to provide information generated by the generation component 104 and/or other information. The provision component 106 may be configured to provide information to different locations based on the format in which the information is arranged. For example, the provision component 106 may be configured to provide information arranged in the cloud-native format (e.g., cloud-native operation information) to one or more cloud-native applications. For example, the provision component 106 may provide information arranged in the JSON format to cloud-native application. The provision component 106 may be configured to provide information arranged in the markup language format to one or more data stores. For example, the provision component 106 may provide information arranged in the WITSML format to WITSML data store(s).

The cloud-native application(s) may utilize the cloud-native operation information to facilitate the operation of the well. The cloud-native operation information may be used by the cloud-native application(s) to facilitate continued operation of the well. In some implementations, the cloud-native application(s) may include a data visualization application, a data analytic application, and/or other cloud-native applications. A data visualization application may refer to an application that provide visualization of data. A data visualization application may refer to an application that represents data in visual form. For example, a data visualization application may use WITSML information (characterizing well operation) that has been converted into JSON information to provide visual representation (e.g., numbers, graphs, plots) of the well operation.

A data analytic application may refer to an application that that performs computation on information, such as inspecting, cleansing, transforming, and/or modeling the information with the goal of discovering useful information, informing conclusion, and/or supporting decision-making. For example, a data analytic application may use JSON information (characterizing well operation) to provide recommendations on future well operation and/or changes to well operation. For instance, a data analytic application may use current values and/or status of well operation to suggest well operation parameter, to determine status of drilling tools (e.g., when equipment being used is likely to fail/has failed), to determine status of the well (e.g., stability of wellbore), to determine status of other wells (e.g., determine when and/or to what extent fracking of a well affects operation of nearby wells), and/or other information that may be used to facilitate the operation of the well.

In some implementations, information output by one or more cloud applications may be provided to one or more data stores. Information output by cloud application(s) may be converted from the cloud-native format to the markup language format before the information is provided to the data store(s). For example, output of the data analytic application may be arranged in the cloud native format (e.g., JavaScript Object Notation format). For instance, the data analytic application may perform data analytics using operation information converted into cloud-native format, and result of the data analytics may be arranged in the cloud-native format. Output of the data analytic application may be converted into the markup language format (e.g., wellsite information transfer standard markup language format). Entirety or portions of the output may be converted and arranged in the markup language format. The converted output of the data analytic application may be provided to the data store(s) for use in the operation of the well.

Implementations of the disclosure may be made in hardware, firmware, software, or any suitable combination thereof. Aspects of the disclosure may be implemented as instructions stored on a machine-readable medium, which may be read and executed by one or more processors. A machine-readable medium may include any mechanism for storing or transmitting information in a form readable by a machine (e.g., a computing device). For example, a tangible computer-readable storage medium may include read-only memory, random access memory, magnetic disk storage media, optical storage media, flash memory devices, and others, and a machine-readable transmission media may include forms of propagated signals, such as carrier waves, infrared signals, digital signals, and others. Firmware, software, routines, or instructions may be described herein in terms of specific exemplary aspects and implementations of the disclosure, and performing certain actions.

In some implementations, some or all of the functionalities attributed herein to the system 10 may be provided by external resources not included in the system 10. External resources may include hosts/sources of information, computing, and/or processing and/or other providers of information, computing, and/or processing outside of the system 10.

Although the processor 11 and the electronic storage 13 are shown to be connected to the interface 12 in FIG. 1, any communication medium may be used to facilitate interaction between any components of the system 10. One or more components of the system 10 may communicate with each other through hard-wired communication, wireless communication, or both. For example, one or more components of the system 10 may communicate with each other through a network. For example, the processor 11 may wirelessly communicate with the electronic storage 13. By way of non-limiting example, wireless communication may include one or more of radio communication, Bluetooth communication, Wi-Fi communication, cellular communication, infrared communication, or other wireless communication. Other types of communications are contemplated by the present disclosure.

Although the processor 11 is shown in FIG. 1 as a single entity, this is for illustrative purposes only. In some implementations, the processor 11 may comprise a plurality of processing units. These processing units may be physically located within the same device, or the processor 11 may represent processing functionality of a plurality of devices operating in coordination. The processor 11 may be separate from and/or be part of one or more components of the system 10. The processor 11 may be configured to execute one or more components by software; hardware; firmware; some combination of software, hardware, and/or firmware; and/or other mechanisms for configuring processing capabilities on the processor 11.

It should be appreciated that although computer program components are illustrated in FIG. 1 as being co-located within a single processing unit, one or more of computer program components may be located remotely from the other computer program components. While computer program components are described as performing or being configured to perform operations, computer program components may comprise instructions which may program processor 11 and/or system 10 to perform the operation.

While computer program components are described herein as being implemented via processor 11 through machine-readable instructions 100, this is merely for ease of reference and is not meant to be limiting. In some implementations, one or more functions of computer program components described herein may be implemented via hardware (e.g., dedicated chip, field-programmable gate array) rather than software. One or more functions of computer program components described herein may be software-implemented, hardware-implemented, or software and hardware-implemented

The description of the functionality provided by the different computer program components described herein is for illustrative purposes, and is not intended to be limiting, as any of computer program components may provide more or less functionality than is described. For example, one or more of computer program components may be eliminated, and some or all of its functionality may be provided by other computer program components. As another example, processor 11 may be configured to execute one or more additional computer program components that may perform some or all of the functionality attributed to one or more of computer program components described herein.

The electronic storage media of the electronic storage 13 may be provided integrally (i.e., substantially non-removable) with one or more components of the system 10 and/or as removable storage that is connectable to one or more components of the system 10 via, for example, a port (e.g., a USB port, a Firewire port, etc.) or a drive (e.g., a disk drive, etc.). The electronic storage 13 may include one or more of optically readable storage media (e.g., optical disks, etc.), magnetically readable storage media (e.g., magnetic tape, magnetic hard drive, floppy drive, etc.), electrical charge-based storage media (e.g., EPROM, EEPROM, RAM, etc.), solid-state storage media (e.g., flash drive, etc.), and/or other electronically readable storage media. The electronic storage 13 may be a separate component within the system 10, or the electronic storage 13 may be provided integrally with one or more other components of the system 10 (e.g., the processor 11). Although the electronic storage 13 is shown in FIG. 1 as a single entity, this is for illustrative purposes only. In some implementations, the electronic storage 13 may comprise a plurality of storage units. These storage units may be physically located within the same device, or the electronic storage 13 may represent storage functionality of a plurality of devices operating in coordination.

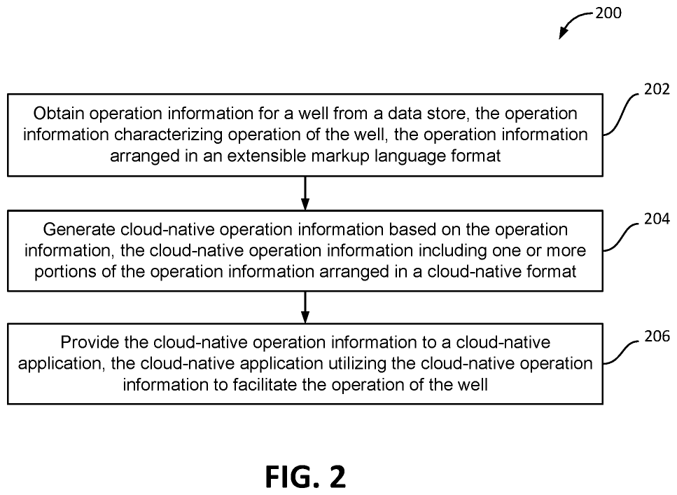

FIG. 2 illustrates method 200 for transforming data for well operations. The operations of method 200 presented below are intended to be illustrative. In some implementations, method 200 may be accomplished with one or more additional operations not described, and/or without one or more of the operations discussed. In some implementations, two or more of the operations may occur substantially simultaneously.

In some implementations, method 200 may be implemented in one or more processing devices (e.g., a digital processor, an analog processor, a digital circuit designed to process information, a central processing unit, a graphics processing unit, a microcontroller, an analog circuit designed to process information, a state machine, and/or other mechanisms for electronically processing information). The one or more processing devices may include one or more devices executing some or all of the operations of method 200 in response to instructions stored electronically on one or more electronic storage media. The one or more processing devices may include one or more devices configured through hardware, firmware, and/or software to be specifically designed for execution of one or more of the operations of method 200.

Referring to FIG. 2 and method 200, at operation 202, operation information for a well and/or other information may be obtained from a data store. The operation information may characterize operation of the well. The operation information may be arranged in an extensible markup language format. In some implementation, operation 202 may be performed by a processor component the same as or similar to the obtain component 102 (Shown in FIG. 1 and described herein).

At operation 204, cloud-native operation information may be generated based on the operation information and/or other information. The cloud-native operation information may include one or more portions of the operation information arranged in a cloud-native format. In some implementation, operation 204 may be performed by a processor component the same as or similar to the generation component 104 (Shown in FIG. 1 and described herein).

At operation 206, the cloud-native operation information may be provided to one or more cloud-native application(s). The cloud-native application(s) may utilize the cloud-native operation information to facilitate the operation of the well. In some implementation, operation 206 may be performed by a processor component the same as or similar to the provision component 106 (Shown in FIG. 1 and described herein).

Although the system(s) and/or method(s) of this disclosure have been described in detail for the purpose of illustration based on what is currently considered to be the most practical and preferred implementations, it is to be understood that such detail is solely for that purpose and that the disclosure is not limited to the disclosed implementations, but, on the contrary, is intended to cover modifications and equivalent arrangements that are within the spirit and scope of the appended claims. For example, it is to be understood that the present disclosure contemplates that, to the extent possible, one or more features of any implementation can be combined with one or more features of any other implementation.

What is claimed is:

1. A system that transforms data for well operations, the system comprising:
one or more physical processors configured by machine-readable instructions to:
obtain operation information for a well from a data store, the operation information characterizing operation of the well, the operation information arranged in an extensible markup language format;
generate cloud-native operation information based on the operation information, the cloud-native operation information including one or more portions of the operation information arranged in a cloud-native format; and
provide the cloud-native operation information to a cloud-native application, the cloud-native application utilizing the cloud-native operation information to facilitate the operation of the well.

2. The system of claim 1, wherein the operation information is obtained from the data store based on a set of queries.

3. The system of claim 2, wherein the set of queries includes a well query, a wellbore query, and an item query.

4. The system of claim 1, wherein the extensible markup language format includes wellsite information transfer standard markup language format.

5. The system of claim 4, wherein the cloud-native format includes JavaScript Object Notation format.

6. The system of claim 5, wherein the operation information is obtained from the data store as one or more wellsite information transfer standard markup language documents, and the cloud-native operation information is generated as one or more JavaScript Object Notation messages.

7. The system of claim 6, wherein the one or more portions of the operation information are arranged in the cloud-native format in the cloud-native operation information based on a list of elements and corresponding data types to be converted from the operation information into the cloud-native operation information.

8. The system of claim 7, wherein the cloud-native application includes a data visualization application or a data analytic application.

9. The system of claim 8, wherein:
output of the data analytic application is arranged in the JavaScript Object Notation format;
output of the data analytic application is converted into the wellsite information transfer standard markup language format; and
the converted output of the data analytic application is provided to the data store for use in the operation of the well.

10. The system of claim 1, wherein the operation of the well includes a drilling operation, a completion operation, or a production operation.

11. A method for transforming data for well operations, the method comprising:
obtaining operation information for a well from a data store, the operation information characterizing operation of the well, the operation information arranged in an extensible markup language format;
generating cloud-native operation information based on the operation information, the cloud-native operation information including one or more portions of the operation information arranged in a cloud-native format; and
providing the cloud-native operation information to a cloud-native application, the cloud-native application utilizing the cloud-native operation information to facilitate the operation of the well.

12. The method of claim 11, wherein the operation information is obtained from the data store based on a set of queries.

13. The method of claim 12, wherein the set of queries includes a well query, a wellbore query, and an item query.

14. The method of claim 11, wherein the extensible markup language format includes wellsite information transfer standard markup language format.

15. The method of claim 14, wherein the cloud-native format includes JavaScript Object Notation format.

16. The method of claim 15, wherein the operation information is obtained from the data store as one or more wellsite information transfer standard markup language documents, and the cloud-native operation information is generated as one or more JavaScript Object Notation messages.

17. The method of claim 16, wherein the one or more portions of the operation information are arranged in the cloud-native format in the cloud-native operation information based on a list of elements and corresponding data types to be converted from the operation information into the cloud-native operation information.

18. The method of claim 17, wherein the cloud-native application includes a data visualization application or a data analytic application.

19. The method of claim 18, wherein:
output of the data analytic application is arranged in the JavaScript Object Notation format;
output of the data analytic application is converted into the wellsite information transfer standard markup language format; and
the converted output of the data analytic application is provided to the data store for use in the operation of the well.

20. The method of claim 11, wherein the operation of the well includes a drilling operation, a completion operation, or a production operation.
